(19) United States
(12) Patent Application Publication
(10) Pub. No.: US 2013/0180896 A1
(43) Pub. Date: Jul. 18, 2013

(54) BEDDING MATERIAL SEPARATOR

(71) Applicants: Paul W. RAMSAY, Holland Centre (CA); Lynn C. RAMSAY, Holland Centre (CA); Rebecca M. SMALL, Holland Centre (CA)

(72) Inventors: Paul W. RAMSAY, Holland Centre (CA); Lynn C. RAMSAY, Holland Centre (CA); Rebecca M. SMALL, Holland Centre (CA)

(21) Appl. No.: 13/348,985

(22) Filed: Jan. 12, 2012

(51) Int. Cl. B07B 1/28

(52) U.S. Cl. 209/235

(57) ABSTRACT

A separator and method is provided for separating used bedding material into waste material and bedding material for re-use. The separator may comprise a frame, a plurality of elongate screening elements fixed to the frame and oriented in-line with a discharge end of the separator, and a rotatable actuator aligned transverse to the plurality of elongate screening elements. The rotatable actuator may have a non-circular cross-section and positioned such that when the rotatable actuator is rotated a greater radius portion of the cross-section is located to cause the plurality of elongate screening elements to deflect from a static position away from a rotational axis of the actuator, and a lesser radius portion of the cross-section is located to permit the elongate screening elements to return to the static position.

### FIELD

The present application relates to a separator. More particularly, the present application relates to a separator for processing used bedding material to separate bedding from waste material.

### BACKGROUND

Wood shavings, wood pellets, sawdust or straw are commonly used as bedding material for horses in stalls. After use, the bedding material may become soiled with mud, manure and other waste material that may clump with the bedding material. A common practice is to muck out a stall to remove soiled bedding and replace the soiled bedding with fresh bedding material. Depending upon the condition of the soiled bedding, it may be possible to separate the bedding material from waste material for reuse.

An example of a prior art bedding separator is disclosed in U.S. Pat. No. 6,685,029. This type of bedding separator provides a grating for receiving used bedding material. The bedding material may fall through the grating, while the waste material slides off an end of the grating. A limitation of this type of bedding separator is that soiled bedding material may be wet and clumped together, making it difficult to efficiently screened.

There is a need for a bedding material separator that overcomes the limitations in the prior art.

### BRIEF DESCRIPTION OF THE DRAWINGS

In drawings which illustrate by way of example only a preferred embodiment of the invention,

FIG. 1 is an isometric view of an embodiment of a separator.

FIG. 2 is a side section view of the separator of FIG. 1.

FIG. 3 is a close-up of the side section view of FIG. 2.

FIG. 4 is an isometric view of an embodiment of a separator.

FIG. 5 is an isometric view of an embodiment of a separator.

FIG. 6 is a side view of an embodiment of a separator in use.

FIG. 7 is a close-up side view of an embodiment of a separator in use.

FIG. 8 is a side view of the embodiment of FIG. 7.

### DETAILED DESCRIPTION OF THE INVENTION

In an embodiment, a separator is provided for separating used bedding material into waste material and bedding material for re-use. The used bedding material may comprise bedding material and waste material such as mud, manure or wet bedding material that tends to clump together. The separator may comprise a frame; a plurality of elongate screening elements fixed to the frame and oriented in-line with a discharge end of the separator; and, a rotatable actuator aligned transverse to the plurality of elongate screening elements, the rotatable actuator having a non-circular cross-section and positioned such that when the rotatable actuator is rotated a deflecting portion of the cross-section deflects the plurality of elongate screening elements from a static position away from a rotational axis of the actuator, and a releasing portion of the cross-section permits the elongate screening elements to return to the static position.

In an aspect, the releasing portion of the cross-section may permit the plurality of elongate screening elements to deflect past the static position towards the rotational axis of the actuator.

In an aspect, a rotator may be provided for rotating the actuator about the rotational axis. The rotator may comprise a cordless electric drill, electric motor or other rotation means.

In an aspect, the frame may be comprised of a metal such as aluminium, or a plastic.

In an aspect, the actuator may comprise a plastic rod having at least one flattened side, the at least one flattened side comprising the releasing portion of the cross-section and a non-flattened portion of the plastic rod comprising the deflecting portion of the cross-section.

In an aspect, the frame may comprise side rails separated by end rails, the end rails supporting the plurality of elongate screening elements. At least one of the end rails may comprises a discharge end rail, the discharge end rail sized to provide purchase on a wall of a container for receiving waste material discharged from the separator.

In an embodiment, a method is provided for separating used bedding material into waste material and bedding material for re-use. The method may comprise depositing the used bedding material onto a plurality of elongate screening elements supported at an angle to the horizontal; rotating a rotatable actuator aligned transverse to the plurality of elongate screening elements, the rotatable actuator having a non-circular cross-section such that upon rotation the actuator alternately deflects the plurality of elongate screening elements away from a static position and permits the plurality of elongate screening elements to return to the static position in an oscillatory motion; and, collecting bedding material below the plurality of elongate screening elements and collecting waste material at a lower discharge end of the elongate screening elements.

In an aspect, the plurality of elongate screening elements may be supported by a container at the lower discharge end and by a wall at an upper support end.

In an aspect, the plurality of elongate screening elements may be supported by a frame at a lower discharge end and an upper support end.

In an aspect, the non-circular cross section of the actuator may permit the plurality of elongate screening elements to return past the static position towards a rotational axis of the actuator when the actuator is rotated.

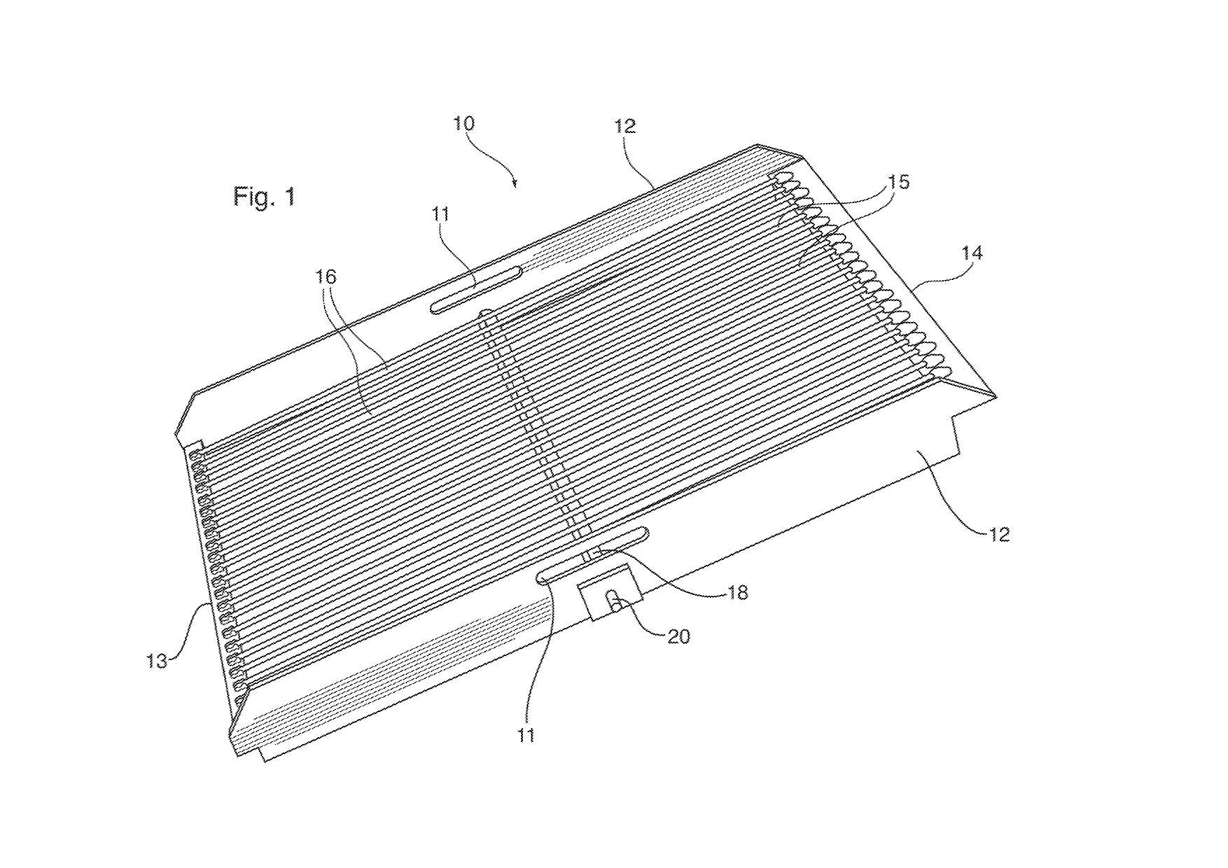

Referring to FIG. 1, an embodiment of a separator 10 is shown in an isometric view. The separator 10 comprises a frame consisting of side rails 12 separated by end rails 13, 14 that support a plurality of elongate screening elements 15. The separator 10 is intended to be oriented at an angle to the horizontal when in use. The end rail 14, intended to be located at a lower discharge end of the separator 10 when oriented at the angle to the horizontal, further comprises a lower discharge end rail 14 for discharging waste material from the separator 10. In an aspect, the discharge end rail may be sized to provide purchase on a wall of a container for receiving waste material discharged from the separator. In the embodiment of FIG. 1, the screening elements 15 are shown as being welded to end rails 13, 14, though other suitable fixation means could be used as an alternative. In the embodiment, handles 11 are illustrated as slots in the side rails 12 to provide areas of purchase to assist in moving the separator 10.

As illustrated in the embodiment of FIG. 1, the screening elements 15 may comprise bars spaced to define screening openings 16 between the side rails 12 and end rails 13, 14 for selected material, such as bedding material, to pass between, thus being separated from waste material that tends to clump and thus does not pass through the screening openings 16.

The embodiment of FIG. 1 further comprises a rotatable actuator 18 for deflecting the screening elements 15 from a static position. In the embodiment, the actuator 18 comprises a rotatable bar with a non-circular cross-section, disposed transverse to the screening elements 15 and positioned such that when rotated, a deflecting portion(s), comprising a greater radius portion(s), of the cross-section may contact the screening elements 15 and cause them to deflect from the static position and a releasing portion(s), comprising a lesser radius portion(s), of the cross-section may permit the screening elements 15 to return to the static position. In an aspect, the releasing portion of the cross-section may provide sufficient clearance to permit the screening elements 15 to deflect past the static position towards the actuator 18, for instance in a vibratory or oscillatory motion about the static position. In the embodiment of FIG. 1, where the screening elements 15 are fixed to both of the end rails 13, 14, the actuator 18 is conveniently located near a middle portion of the actuators 18 so as to more easily deflect the actuators 18 from the static position.

The term “greater radius portion” being used to identify portions of the cross-section having a greater radius magnitude sufficiently large to cause an interference with the plurality of screening elements in relation to their static position. The term “lesser radius portion” being used to identify portions of the cross-section having a lesser radius magnitude sufficiently small to cause no interference with the plurality of screening elements in relation to their static position. In an aspect, the lesser radius magnitude may be sufficiently small to cause no interference with the plurality of screening elements in relation to a return deflected position located between the static position and, a rotational axis of the cross-section. In an aspect, the rotator may comprise a rod having a circular cross-section portion that comprises the deflecting portion and a flatted cross-section portion that comprises the releasing portion.

In the embodiment of FIG. 1, a portion of the actuator 18 may extend past the side rail 12 in the form of a spindle 20 for rotation by a rotator, such as an electric motor or drill.

In an embodiment the screening elements 15 may comprise metal or plastic bars, and the actuator 18 may comprise a rod that has sufficient strength to cause a deflection of the screening elements 15 and has a low enough coefficient of friction to allow rotation of the actuator 18 with a reasonable torque applied to the spindle 20. By way of example, the rod may comprise a metal. Alternatively, the rod may comprise a plastic such as UHMW polyethylene and HDPE which are commonly used plastics that may be suitable. In an aspect, the frame may be comprised of a metal, such as steel or aluminum, or a plastic.

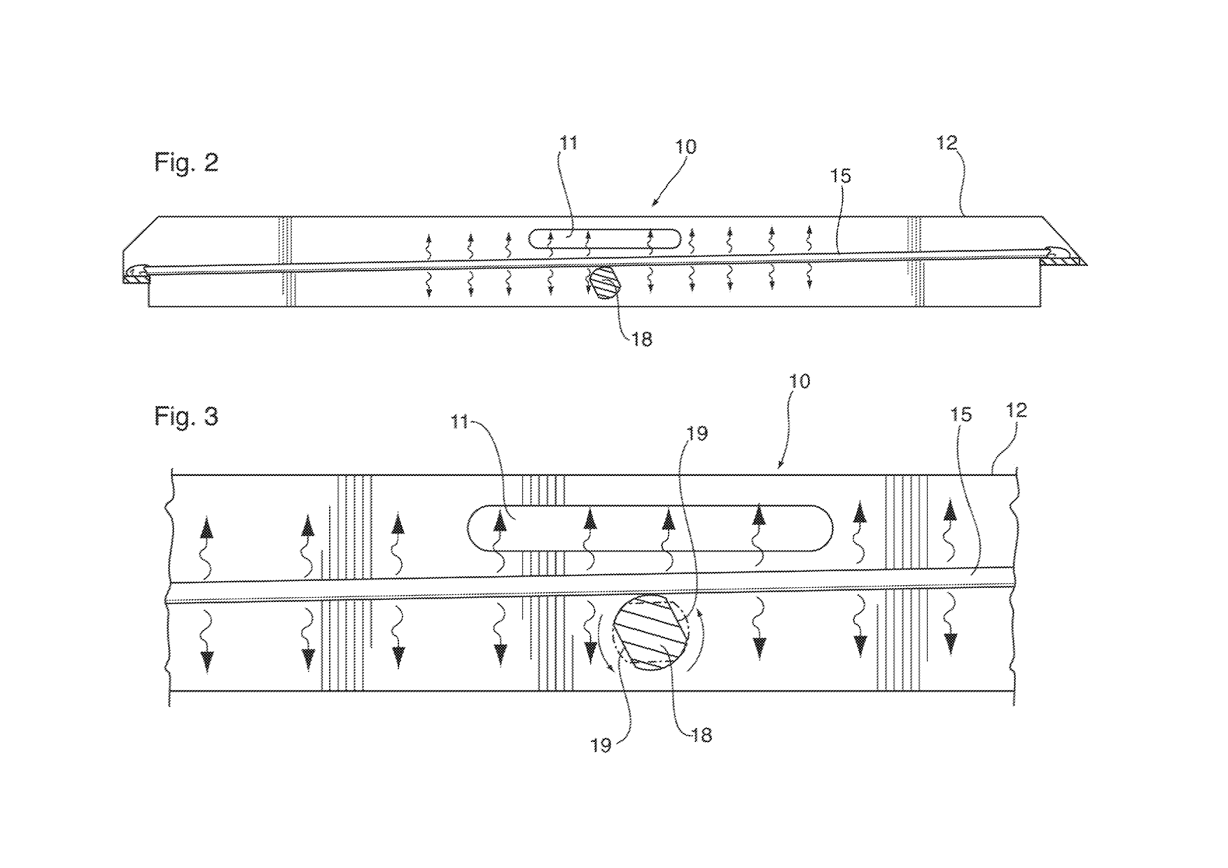

FIG. 2 is a side section view of the separator 10 of FIG. 1. The actuator 18 illustrated comprises a rod having a generally circular cross-section with two flattened portions 19 that comprise the releasing portions of the cross-section. In the embodiment of FIG. 2, the flattened portions 19 provide sufficient clearance for the screening elements 15 to deflect down from the static position toward a rotational axis of the actuator 18.

FIG. 3 is a close-up view of the side section view of FIG. 2, centred on the actuator 18.

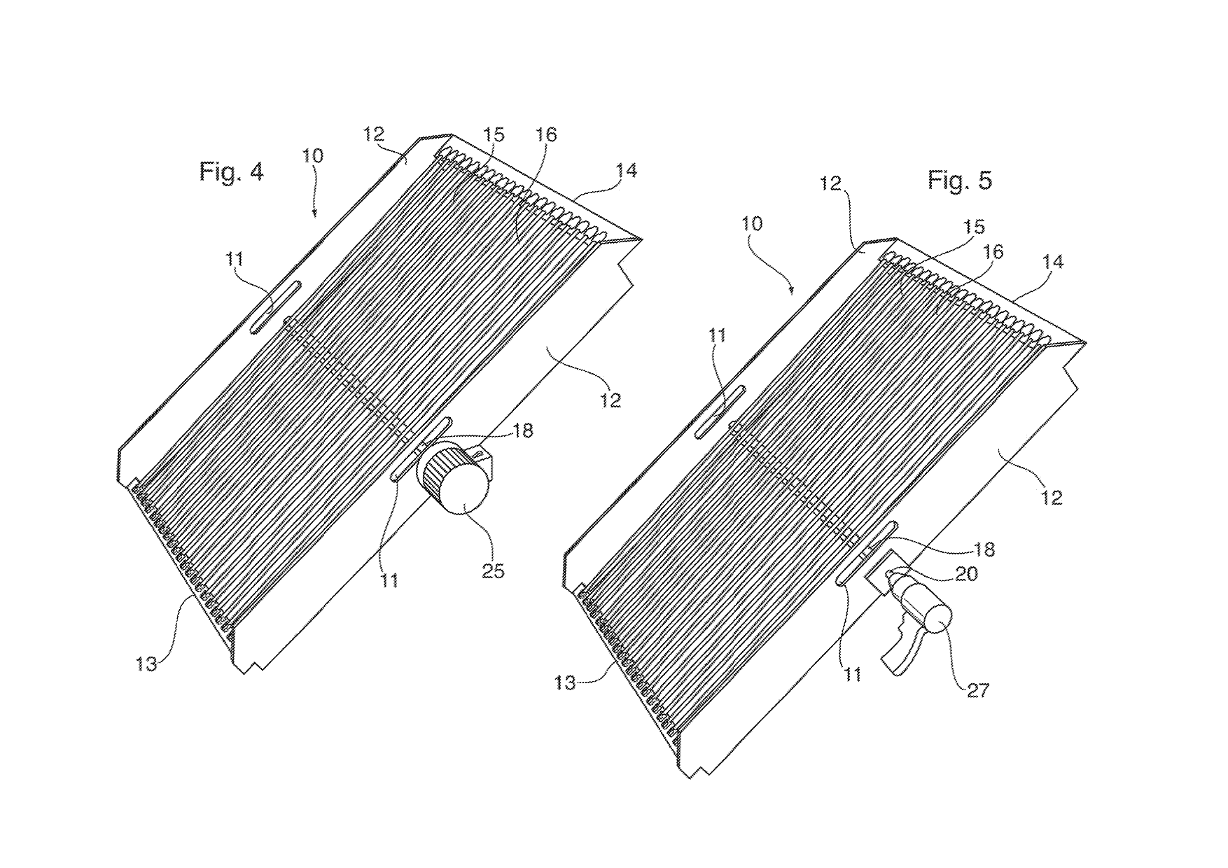

FIG. 4 is an isometric view of an embodiment of a separator 10 where the rotator comprises an electric motor 25.

FIG. 5 is an isometric view of an embodiment of a separator 10 where the rotator is an electric drill 27. In an aspect, the electric drill 27 may comprise a cordless electric drill. The cordless electric drill may provide for a separator that is portable and readily powered in remote locations away from wired power connections. An advantage is that a cordless electric drill may be removed from the separator 10 when not in use. In an aspect, the cordless electric drill may be paired with an aluminum or plastic frame to assist in providing a mobile separator 10.

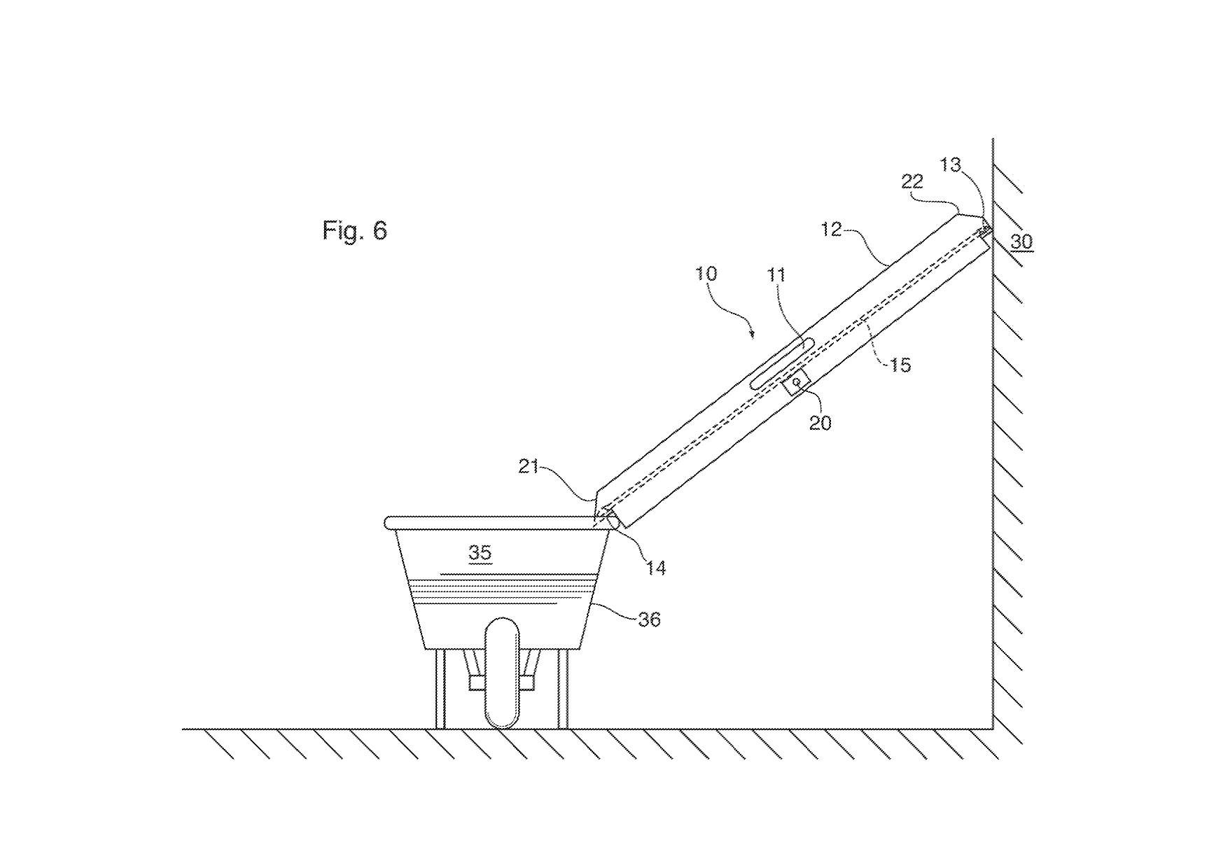

FIG. 6 is a side view of a separator 10 in position for operation supported at a lower discharge end 21 by a container and at an upper support end 22 by a wall 30. In FIG. 6, the container conveniently comprises a wheel barrow 35 to simplify removal of waste material, though other containers may be used in place of the wheel barrow 35. In the embodiment of FIG. 6, the wheelbarrow 35 and wall 30 provide support for the separator 10. Material to be separated, such as used bedding material, may be deposited on the screening elements 15, and the spindle 20 rotated by a rotator (not shown in this view), such as the cordless drill of FIG. 5. Upon rotation of the spindle 20, the actuator 18 may rotate about its rotational axis, and the deflecting portion(s) (greater radius portion(s)) of the cross-section contacting the screening elements 15 and deflecting them from the static position to a maximum deflected position away from the rotational axis of the actuator 18. The static position being between the maximum deflected position and the rotational axis of the actuator 18. With further rotation, the releasing portion(s) (lesser radius portion(s)) of the actuator may be presented to the screening elements 15, allowing them to return to the static position, and in some embodiments deflect past the static position to a minimum deflected position towards the rotational axis of the actuator 18. The minimum deflected position in these embodiments being either the static position or between the static position and the rotational axis of the actuator 18 depending upon a lesser radius magnitude of the releasing portion(s).

With repeated rotation of the spindle 20, the screening elements 15 may oscillate between the maximum deflected position and the minimum deflected position. The oscillating action assisting in the screening action imparted to used bedding material deposited on the screening elements 15.

The oscillating action may also assist in clearing the screening elements 15 by discharging waste material, such as mud and manure which may be mixed with the bedding material of the used bedding material, from the lower discharge end 21. Under the oscillating action, used bedding material deposited on the screening elements 15 may be separated into selected material, such as bedding material, sized to fall through the screening openings 16 to land under the separator 10 and clumped waste material that may slide down the oscillating screening elements 15 past the discharge end rail 14 and off the lower discharge end 21 to fall on the floor or be deposited into a container such as the wheelbarrow 35 for disposal. In the embodiment of FIG. 6, the discharge end rail 14 may conveniently be sized to provide a lip or support surface for resting on a wall 36 of the wheelbarrow 35.

A second container or wheelbarrow 35 may be located under the separator 10 to collect the bedding material separated from the waste material if desired.

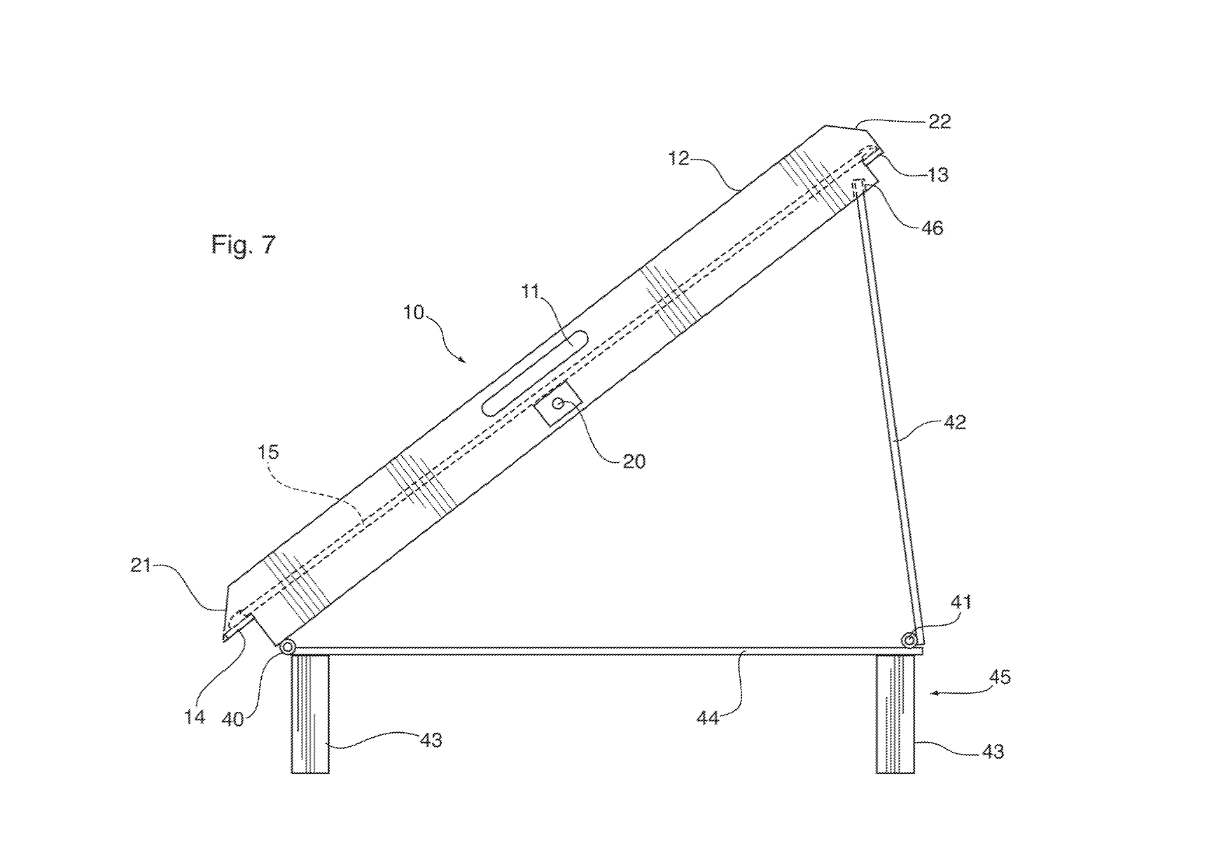

FIG. 7 illustrates an embodiment where the separator 10 at the lower end 21 and the upper support end 22 is supported on a frame 45. The frame 45 comprising legs 43 supporting a base 44. The separator 10 being affixed at the discharge rail 14 to one edge of the base 44 by a hinge 40. A support 42 attached to the base 44 by a hinge 41, is received by a pocket 46 to support the separator 10 at an angle to the horizontal to allow for screening used bedding material deposited onto the separator 10.

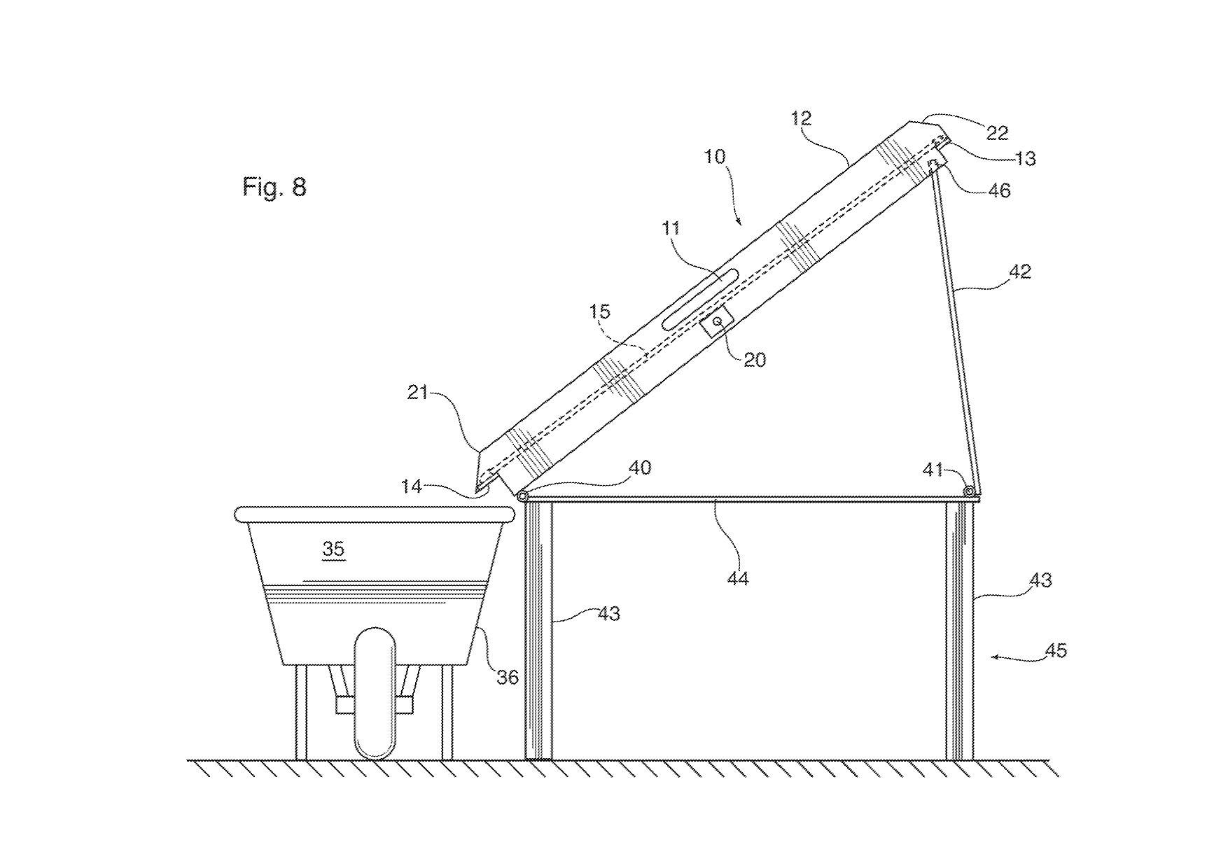

In the embodiment of FIG. 8, the separator 10 is supported by the frame 45 to allow screening of selected material, such as bedding material, which may fall through the screening openings 16, from waste material which may slide along the screening elements 15 to leave the separator 10 at the discharge end rail 14. In the embodiment, the legs 43 of the frame 45 are sized to locate the discharge end rail 14 of the separator 10 above the wall 36 of the wheelbarrow 35.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A separator for separating used bedding material into waste material and bedding material for re-use, the separator comprising:
a frame;
a plurality of elongate screening elements fixed to the frame and oriented in-line with a discharge end of the separator; and,
a rotatable actuator aligned transverse to the plurality of elongate screening elements, the rotatable actuator having a non-circular cross-section and positioned to intermittently contact the plurality of screening elements such that when the rotatable actuator is rotated a deflecting portion of the cross-section deflects the plurality of elongate screening elements from a static position away from a rotational axis of the actuator, and a releasing portion of the cross-section permits the elongate screening elements to return to the static position.

2. The separator of claim 1 wherein the releasing portion of the cross-section permits the plurality of elongate screening elements to deflect past the static position towards the rotational axis of the actuator.

3. The separator of claim 1 further comprising a rotator for rotating the actuator about the rotational axis.

4. The separator of claim 3 wherein the rotator comprises a cordless electric drill.

5. The separator of claim 4 wherein the frame is comprised of aluminium.

6. The separator of claim 3 wherein the rotator comprises an electric motor.

7. The separator of claim 1 wherein the actuator comprises a plastic rod having at least one flattened portion, the at least one flattened portion comprising the releasing portion of the cross-section and a non-flattened portion comprises the deflecting portion of the cross-section.

8. The separator of claim 1 wherein the frame comprises side rails separated by end rails, the end rails supporting the plurality of elongate screening elements.

9. The separator of claim 8 wherein at least one of the end rails comprises a discharge end rail, the discharge end rail sized to provide purchase on a wall of a container for receiving waste material discharged from the separator.

10. The separator of claim 1 wherein the frame is comprised of plastic.

11. A method for separating used bedding material into waste material and bedding material for re-use, the method comprising:
depositing the used bedding material onto a plurality of elongate screening elements supported at an angle to the horizontal;
rotating a rotatable actuator aligned transverse to the plurality of elongate screening elements, the rotatable actuator having a non-circular cross-section such that upon rotation the actuator alternately deflects the plurality of elongate screening elements away from a static position and permits the plurality of elongate screening elements to return to the static position in an oscillatory motion; and,
collecting bedding material below the plurality of elongate screening elements and collecting waste material at a lower discharge end of the elongate screening elements.

12. The method of claim 11 wherein the plurality of elongate screening elements are supported by a container at the lower discharge end and by a wall at an upper support end.

13. The method of claim 11 wherein the plurality of elongate screening elements are supported by a frame at a lower discharge end and an upper support end.

14. The method of claim 11 wherein the rotatable actuator is rotated by a cordless electric drill.

15. The method of claim 11 wherein the non-circular cross section permits the plurality of elongate screening elements to return past the static position towards a rotational axis of the actuator.
